(19) United States
(12) Patent Application Publication
(10) Pub. No.: US 2015/0108065 A1
(43) Pub. Date: Apr. 23, 2015

(54) METHOD FOR WASTEWATER TREATMENT

(71) Applicant: Jiangxi JDL Environmental Protection Co., Ltd., Nanchang (CN)

(72) Inventors: Zhimin LIAO, Nanchang (CN); Kun TAO, Nanchang (CN); Jianzhong XIONG, Nanchang (CN); Rongzhong ZHOU, Nanchang (CN); Kai ZENG, Nanchang (CN); Huaqiong LIU, Nanchang (CN); Can ZOU, Nanchang (CN); Wenxuan LI, Nanchang (CN); Fangfang WANG, Nanchang (CN); Jun XIAO, Nanchang (CN); Jiaojiao HU, Nanchang (CN); Yingying XU, Nanchang (CN); Jinwen XIE, Nanchang (CN); Fan YANG, Nanchang (CN); Kun LI, Nanchang (CN); Jinfeng LIU, Nanchang (CN); Yilin DENG, Nanchang (CN); Zi WANG, Nanchang (CN); Zhenrong XU, Nanchang (CN); Yanlong WANG, Nanchang (CN)

(73) Assignee: Jiangxi JDL Environmental Protection Co., Ltd., Nanchang (CN)

(21) Appl. No.: 14/280,552

(22) Filed: May 16, 2014

(30) Foreign Application Priority Data
Oct. 22, 2013 (CN) 201310496976.8

(51) Int. Cl. C02F 3/28

(52) U.S. Cl. CPC C02F 3/2853
USPC 210/601

(57) ABSTRACT

A method for wastewater treatment in a bioreactor, comprises recycling organic sludge in the bioreactor to supply carbon sources for removing nitrogen and phosphor and increase organic loading of the reactor, and adjusting operational parameters for the bioreactor to form facultative-anaerobic environment or anaerobic environment in the bioreactor. By following the method of the present invention, recycling sludge and simultaneously removing nitrogen and phosphor are completed such that the treatment processes for wastewater disposal are simplified; the sludge is recycled as carbon sources in the bioreactor such that saving resources is realized and the carbon emission into atmosphere is reduced; and zero-amount sludge is discharged such that harm from secondary pollution is avoided.

### CROSS-REFERENCE TO RELATED APPLICATIONS

Pursuant to 35 U.S.C. §119 and the Paris Convention Treaty, this application claims the benefit of Chinese Patent Application No. 201310496976.8 filed on Oct. 22, 2013, the contents of which are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a method for wastewater treatment, and particularly to a method for discharging zero-amount sludge and simultaneously removing carbon, nitrogen, and phosphor in wastewater treatment.

2. Description of the Related Art

For the past few years in China, constructions in urban sewage disposal works have been completed in the main, and constructions in township and village sewage disposal works have been started. However, since township and village wastewater is mainly mixture of domestic wastewater and livestock wastewater (wastewater mixture), the pollutants in township and village wastewater have high concentrations and are widely dispersed so that the management and treatment for the township and village wastewater are difficult. Therefore, Wastewater mixture has raised a major issue in environment of China nowadays, and an efficient way for disposal of wastewater mixture is urgently and importantly required. Conventional methods for treating wastewater have the following problems: (1) the implementation is difficult (the design is not standardized, the efficiency is low, and the required space is large); (2) the effluent level is unstable (the management is complex, and the effluent level highly depends on seasonal factors); and (3) the pollution to the environment are severe (the residual organic sludge is discharged out to environment, and odors are produced).

### SUMMARY OF THE INVENTION

In view of the above described problem, it is one objective of the invention to provide a method for disposal of wastewater that features in easy implementation, stable effluent level, and amicable effects in environment, which is highly applicable for treating wastewater mixture.

To achieve the above objectives, the present invention provides a method for treating sludge and simultaneously removing nitrogen and phosphor in a facultative-anaerobic-adapted membrane bioreactor (FMBR) for wastewater treatment by recycling organic sludge to increase organic loading of the bioreactor.

According to one aspect of the present invention, there is provided a method for discharging zero-amount sludge and simultaneously removing carbon, nitrogen, and phosphor. The method comprises recycling organic sludge in the bioreactor to supply carbon sources for removing nitrogen and phosphor to increase organic loading of the bioreactor, and adjusting operational parameters for the bioreactor to form facultative-anaerobic environment or anaerobic environment in the bioreactor to generate microorganisms comprising facultative anaerobic microorganisms as the dominant microorganisms. By following the method of the present invention, the degradations in carbon compounds, nitrogenous compounds, and phosphorous compounds are conducted simultaneously in the same bioreactor, and the organic compounds in the wastewater are degraded to carbon dioxide, nitrogen gas, phosphine, phosphanylphosphane, and water.

The advantages of the present invention include: the adaptability of the method is highly increased because it is friendly to environment and no sludge is discharged and correspondingly there are more options in selecting the locations of the sewage treatment works; the efficiency in treatment is significantly increased because the sludge is eliminated and the nitrogen and phosphor are removed simultaneously; saving resources and reducing carbon emission to the atmosphere is realized because the sludge is recycled; secondary pollution is effectively avoided because no sludge is emitted.

### DETAILED DESCRIPTION OF THE EMBODIMENTS

Exemplary embodiments of the present invention will be described below.

In the method of the present invention, a facultative-anaerobic condition or an anaerobic condition is formed in the bioreactor such that organic compounds are transformed into carbon dioxide and water, and etc., because of the self-metabolism of the microorganisms in the wastewater; and the died microorganisms are decomposed as nutritional sources for other lived microorganisms. Therefore, a dynamic balance exists in the organic sludge in the bioreactor, and a near-zero emission of sludge is realized. The reaction processes are illustrated as below:

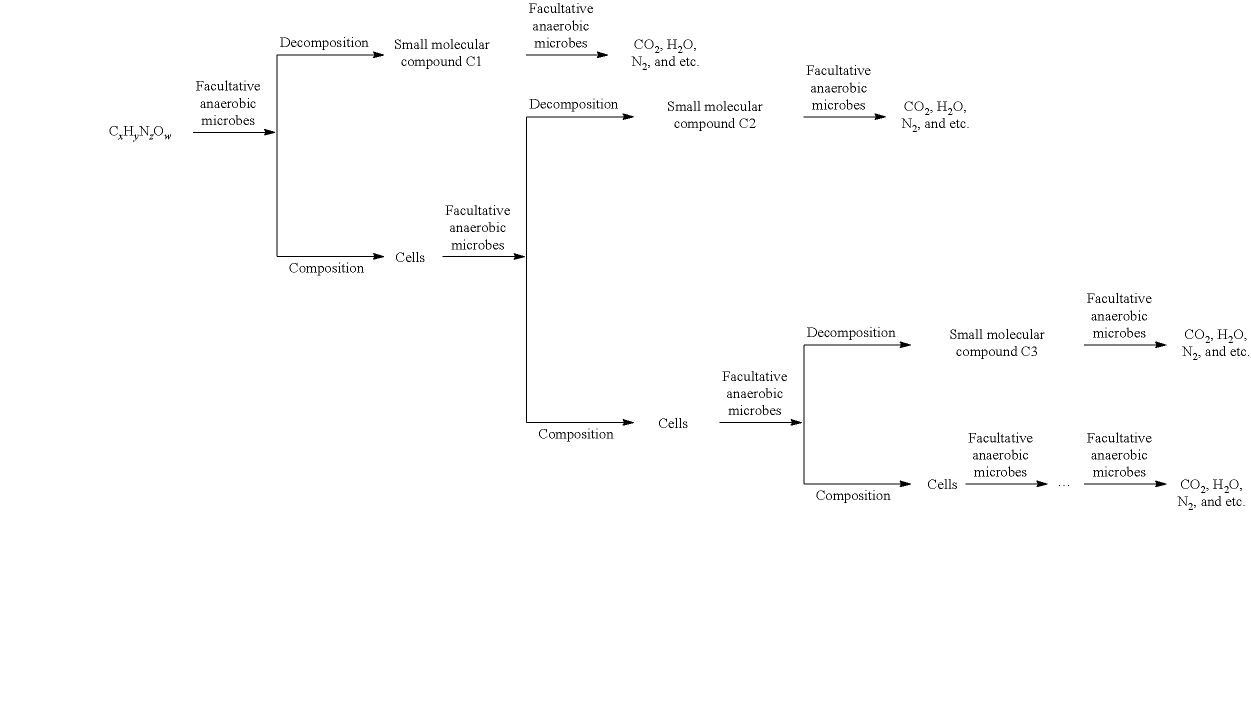

In the method of the present invention, since a facultative-anaerobic environment or anaerobic environment is formed in the bioreactor in the present invention, the microbes in the bioreactor metabolizes in itself to transform phosphor in the wastewater into chemical materials of the cells, and then the chemical materials are transformed into phosphine and phosphanylphosphane via a biological cycle. The reaction processes for phosphor in the method are described as below:

Carbon sources+Phosphates+Facultative anaerobic microbes→Cells (Organophosphorus compounds) Cells (Organophosphorus compounds)+Facultative anaerobic microbes→P₂H₄/PH₃

In the method of the present invention, since a facultative-anaerobic environment or anaerobic environment is formed in the bioreactor in the present invention, the microorganisms in the bioreactor metabolizes to transform ammonium nitrogen into nitrogen gas. The reaction processes for nitrogen in the method are described as below:

$$\frac{1}{2} {NH}_{4}^{+} + \frac{1}{2} {H}_{2} O + \frac{1}{4} {O}_{2} + Facultative anaerobic microbes -> \frac{1}{2} {NO}_{2}^{-} + 2 e + 3 {H}^{+}$$

$$\frac{1}{2} {NH}_{4}^{+} + \frac{1}{2} {NO}_{2}^{-} + Facultative anaerobic microbes -> \frac{1}{2} {N}_{2} + {H}_{2} O$$

### Example 1

In an example of treating wastewater in town A, BOD₅ (Biochemical Oxygen Demand in five days) of the influent is 200 mg/L, COD (Chemical Oxygen Demand) of the influent is 305 mg/L, the concentration of ammonium nitrogen in the influent is 10.49 mg/L, and the total concentration of phosphor in the influent is 2.10 mg/L. After pre-treatment, the wastewater enters directly into the FMBR, the treating processes are conducted successively, and no sludge is emitted. All processes are conducted in the FMBR, by increasing organic loading (supplying carbon sources) of the bioreactor through recycling the organic sludge, and by remaining the bioreactor in a facultative-anaerobic condition or anaerobic condition through controlling the effective parameters of the bioreactor, the metabolism of the facultative anaerobic microbes and the biological recycling processes occur such that the sludged are treated and the nitrogen and phosphor are removed at the same time, and the organic pollutants are decomposed into gases including carbon dioxide, nitrogen gas, phosphine, and phosphanylphosphane to be emitted in the air. After treating with the method of the present invention, BOD₅ of the effluent is 1.0 mg/L, COD of the effluent is 10.6 mg/L, the concentration of ammonium nitrogen in the effluent is 0.64 mg/L, and the total concentration of phosphor in the effluent is 0.2 mg/L. The assessment indicators for quality of the wastewater treatment of the present invention are better than that in the first grade A in standards Discharge standard of pollutants for municipal wastewater treatment plant (GB18918-2002).

### Example 2

In an example of treating wastewater in Village B, BOD₅ of the influent is 410 mg/L, COD of the influent is 609 mg/L, the concentration of ammonium nitrogen in the influent is 20.96 mg/L, and the total concentration of phosphor in the influent is 4.10 mg/L. After pre-treatment, the wastewater enters directly into the FMBR, the treating processes are conducted successively, and no sludge is emitted. All processes are conducted in the FMBR, by increasing organic loading (supplying carbon sources) of the bioreactor through recycling the organic sludge, and by remaining the bioreactor in a facultative-anaerobic condition or anaerobic condition through controlling the effective parameters of the bioreactor, the metabolism of the facultative anaerobic microbes and the biological recycling processes occur such that the sludged are treated and at the same time the nitrogen and phosphor are removed and the organic pollutants are decomposed into gases including carbon dioxide, nitrogen gas, phosphine, and phosphanylphosphane to be emitted in the air. After treating with the method of the present invention, BOD₅ of the effluent is 1.8 mg/L, COD of the effluent is 16.6 mg/L, the concentration of ammonium nitrogen in the effluent is 0.83 mg/L, and the total concentration of phosphor in the effluent is 0.34 mg/L. The assessment indicators for quality of the wastewater treatment of the present invention are better than that in the first grade A in standards Discharge standard of pollutants for municipal wastewater treatment plant (GB18918-2002).

The terms “facultative-anaerobic environment or anaerobic environment” or “facultative-anaerobic condition or anaerobic condition” direct to an environment (condition) where facultative anaerobic microorganisms (or facultative anaerobic microbes) are dominant in all microorganisms in the bioreactor. In addition, the term “facultative-anaerobic-adapted membrane bioreactor” means a membrane bioreactor where a facultative-anaerobic environment or anaerobic environment is formed. The terms “microbe” and “microorganism” mean the same.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for wastewater treatment in a bioreactor, comprising:
recycling organic sludge in the bioreactor to increase organic loading of the bioreactor and supply carbon sources for processes of removing nitrogen and phosphor; and
adjusting operational parameters for the bioreactor to form facultative-anaerobic environment or anaerobic environment in the bioreactor to generate microbes comprising facultative anaerobic microbes as the dominant microbes.

2. The method of claim 1, removing carbon, removing nitrogen, and removing phosphor are conducted simultaneously.

3. The method of claim 1, organic compounds in wastewater are transformed into carbon dioxide, nitrogen gas, phosphine, phosphanylphosphane, and water.
